(19) United States
(12) Patent Application Publication
(10) Pub. No.: US 2022/0048138 A1
(43) Pub. Date: Feb. 17, 2022

(54) Method for Improving the Strength and Ductility of Brittle Intermetallic Alloys through Additive Manufacturing

(71) Applicants: National Technology & Engineering Solutions of Sandia, LLC, Albuquerque, NM (US); Lehigh University, Bethlehem, PA (US)

(72) Inventors: Andrew Kustas, Albuquerque, NM (US); Donald F. Susan, Albuquerque, NM (US); Tomas Farley Babuska, Tallahassee, FL (US); Kyle Johnson, Starkville, MS (US); Brandon Krick, Tallahassee, FL (US); Trevor Verdonik, Schuylkill Haven, PA (US)

(21) Appl. No.: 16/991,203

(22) Filed: Aug. 12, 2020

(51) Int. Cl. B23K 26/342; B33Y 10/00; B33Y 70/00; C22C 38/10; B23K 26/082

(52) U.S. Cl. CPC B23K 26/342; B33Y 10/00; B23K 26/082; C22C 38/10; B33Y 70/00

(57) ABSTRACT

The present invention provides an additive manufacturing (AM) processing and design approach using removable “heat sink” artifacts to tailor the mechanical properties of traditionally low strength and low ductility alloys. As an example, the design approach was demonstrated with the Fe-50 at. % Co alloy, as a model material of interest for electromagnetic applications. AM-processed components exhibited unprecedented performance, with a 300% increase in strength and an order-of-magnitude improvement in ductility relative to conventional wrought material. The method enables the design and processing of high-performance, next-generation components and alloys.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to additive manufacturing and, in particular, to a method for improving the strength and ductility of brittle intermetallic alloys through additive manufacturing.

### BACKGROUND OF THE INVENTION

Additive Manufacturing (AM) has seen tremendous growth in recent decades, largely motivated by opportunities to accelerate next-generation manufacturing processes and novel materials development. Principal and most well-discussed among the advantages of layerwise AM processing is the opportunity to implement exceptional design freedom, allowing the production of complex component geometries that are unachievable with conventional manufacturing techniques. See W. J. Sames et al., Int. Mater. Rev. 61, 315 (2016); W. E. Frazier, J. Mater. Eng. Perform. 23, 1917 (2014); and D. Herzog et al., Acta Mater. 117, 371 (2016). Navigation of this broad design space, often termed as “Design for Additive Manufacturing”, has been discussed in detail in the literature at various part, material, and product levels, and include aspects of both material performance and processing constraints. See M. K. Thompson et al., CIRP Ann.—Manuf. Technol. 65, 737 (2016). For parts, design opportunities include those that integrate material and geometric features toward enhancing functionality and production efficiency, such as conformal cooling, topology optimization for high strength-to-weight ratio, and cost-effective customized components. See M. K. Thompson et al., CIRP Ann.—Manuf. Technol. 65, 737 (2016); M. Garibaldi et al., J. Mech. Des. 141, 071401 (2019); and A. D. Dressler et al., Addit. Manuf. 28, 692 (2019). For material, the design space largely takes advantage of customized materials and micro/macrostructures that enable new properties and functionality. Some examples include customized powders and feedstock, tailored surfaces and porosity, and functionally graded materials. See I. E. Anderson et al., Curr. Opin. Solid State Mater. Sci. 22, 8 (2018); and D. C. Hofmann et al., J. Mater. Res. 29, 1899 (2014). Finally, at the product level, the design space encompasses the control of part consolidation, embedded parts, and the elimination of production assemblies. While these examples of additive design clearly exploit the advantageous processing characteristics of near-net-shape AM processing, the material properties of the constructed component remain, in many cases, inferior to conventionally processed wrought material.

An exemplary material is binary Fe—50Co alloy, a brittle intermetallic alloy of interest to electromagnetic applications. Fe—50Co, referred to hereafter as Fe—Co, exhibits exceptional magnetic properties that include high permeability, low coercivity, and high saturation induction, making these alloys ideal for use in a variety of electromagnetic devices. See T. Sourmail, Prog. Mater. Sci. 50, 816 (2005); and R. S. Sundar et al., J. Mater. Res. 20, 1515 (2005). However, when conventionally produced, this alloy is characterized by prohibitively low strength (200-400 MPa) and near-zero ductility (maximum 4% strain-at-failure), which challenges conventional processing and limits the application potential, for example in the aerospace industry. See T. Sourmail, Prog. Mater. Sci. 50, 816 (2005); and R. S. Sundar and S. C. Deevi, Soft magnetic FeCo alloys: alloy development, processing, and properties (2005). The poor mechanical properties of Fe—Co are proposed to be the result of a transition from disordered BCC to ordered B2 phases, which requires cooling rates in excess of 10³° C./s to suppress, impractical for most conventional manufacturing methods. See D. W. Clegg and R. A. Buckley, Met. Sci. J. 7, 48 (1973); A. B. Kustas et al., Addit. Manuf. 21, 41 (2018); and M. Rajkovic et al., Met. Sci. 15, 21 (1981). The binary Fe—Co alloy has such unfavorable mechanical properties that, despite its functional performance, has never been commercialized in bulk form. See T. Sourmail, Prog. Mater. Sci. 50, 816 (2005). Rather, modified alloy compositions based on the Fe—Co binary system are routinely utilized, for example with small additions of ternary additives such as V and Nb. See K. Kawahara, J. Mater. Sci. 18, 1709 (1983). However, these commercial Fe—Co alloys (e.g., Fe—Co—2V Hiperco®, Permendur®) exhibit comparably harder magnetic properties, such as lower permeability and higher coercivity, leading to higher energy loss and larger/heavier electromagnetic devices. See T. Sourmail, Prog. Mater. Sci. 50, 816 (2005); and R. S. Sundar and S. C. Deevi, Soft magnetic FeCo alloys: alloy development, processing, and properties (2005). Substantial effort has been focused on developing techniques to process brittle magnetic alloys with optimal composition, however, they are largely limited to small volumes of material that remain brittle. See C. C. Lima et al., J. Alloys Compd. 586, S314 (2014); N. E. Fenineche et al., Mater. Lett. 58, 1797 (2004); Z. Turgut et al., J. Appl. Phys. 83, 6468 (1998); J. Xie et al., Intermetallics. 23, 20 (2012); E. J. Yun et al., IEEE Trans. Magn. 32, 4535 (1996); C. L. Platt et al., J. Appl. Phys. 88, 2058 (2000); G. Tian and X. Bi, J. Alloys Compd. 502, 1 (2010); Y. Shimada and H. Kojima, J. Appl. Phys. 47, 4156 (1976); R. Li et al., J. Magn. Magn. Mater. 281, 135 (2004); H. Haiji et al., J. Magn. Magn. Mater. 160 (1996); Y. Takada et al., J. Appl. Phys. 64, 5367 (1988); M. Abe et al., J. Mater. Eng. 11, 109 (1989); M. Abdellaoui et al., J. Alloys Compd. 198, 155 (1983); C. Kuhrt and L. Schultz, J. Appl. Phys. 73, 6588 (1993); A. B. Kustas et al., J. Mater. Process. Technol. 257 (2018); A. B. Kustas et al., Metall. Mater. Trans. A Phys. Metall. Mater. Sci. 47, 3095 (2016); and B. Zhang et al., J. Magn. Magn. Mater. 324, 495 (2012). Emerging efforts in 3D printing of soft magnetic alloys with novel compositions are aimed toward producing components with unprecedented energy conversion efficiency. See G. Rolink et al., J. Mater. Res. 29, 2036 (2014); M. Garibaldi et al., Acta Mater. 110, 207 (2016); M. Garibaldi et al., Scr. Mater. 142, 121 (2018); M. Garibaldi et al., Mater. Charact. 1 (2018); C. V. Mikler et al., Jom. 69, 532 (2017); C. V. Mikler et al., Mater. Lett. 199, 88 (2017); C. V. Mikler et al., Mater. Lett. 192, 9 (2017); J. Geng et al., Jom. 68, 1972 (2016); A. Plotkowski et al., Addit. Manuf., 100781 (2019); A. B. Kustas et al., Addit. Manuf. 28, 772 (2019); and T. Riipinen et al., Rapid Prototyp. J. 25, 699 (2019).

Thus, while the design opportunities enabled by AM processing may promote improved performance margins relative to conventionally manufactured geometries, there remains a need for enhancing material performance for a given set of geometric and environmental constraints via control of the part construction.

### SUMMARY OF THE INVENTION

The present invention is directed to a laser powder bed fusion (LPBF) AM processing method that enables drastically improved performance in a traditionally low strength, low ductility components and material systems. The method improves the general manufacturability of a component by overcoming inherent constraints associated with the process. Specifically, an arbitrary component shape can be produced via LPBF concomitantly with removable secondary artifacts, i.e., “heat sink” struts, to tailor the final component properties without modifying the final end-use geometry or part orientation. In particular, thermal profile of the component can be modified to keep the temperature of the intermetallic alloy below an alloy ordering temperature in order to keep the atomic mobility low and avoid excessive chemical ordering. For example, the method can be used with alloys that have a disordered BCC lattice that can transform to the B2 phase, whereby this transformation is suppressed. Intermetallic alloys that exhibit this transformation include, for example, Fe—Co, Fe—Al, and Fe—Si.

The mechanical properties of the LPBF process-modified specimens greatly exceed conventionally processed and LPBF-processed material without the secondary features, in some cases by up to an order-of-magnitude. Further, the method to improve mechanical properties can be used with other solidification-based additive processes when applied to traditionally brittle intermetallic alloys having disorder-order phase transformations.

As an example of the invention, a novel removable heat sink artifact design, uniquely enabled by metal additive manufacturing, was shown to drastically improve the performance of a traditionally low strength and low ductility Fe—Co alloy. The combination of yield strength and ductility of the AM-processed material was unprecedented, with a 300% increase in strength and an order-of-magnitude improvement in ductility relative to conventional wrought material. Thermal AM process simulations indicated that the design without heat sinks reached a much higher temperature during processing for a prolonged time, likely leading to a higher degree of atomic ordering. The processing temperatures seen in the simulations for designs with heat sinks were generally much lower, suggesting increased atomic disorder. Production and testing/use yield were also shown to drastically improve with the addition of the heat sink artifacts.

By utilizing a combination of “Design for Additive Manufacturing” principles with detailed fundamental materials understanding, revolutionary improvements in component performance can be realized. The designed processing methodology, unique to layerwise AM, is enables the development of higher performance alloys and net-shape devices. In terms of potential application impact, aerospace technologies, such as power generating units, internal generators for propulsion engines, and magnetic bearings, would benefit from the use of high strength and high ductility soft magnetic alloys.

### BRIEF DESCRIPTION OF THE DRAWINGS

The detailed description will refer to the following drawings, wherein like elements are referred to by like numbers.

FIG. 1A is a schematic illustration of a LPBF printing process. FIG. 1B is a schematic illustration of LPBF printing of an exemplary tensile specimen.

FIGS. 2A-2C show tensile stress vs. strain curves for the three additively manufactured design approaches. Specimens processed without heat sink struts (FIG. 2A) exhibited significantly lower ductility than those produced with artifacts (FIGS. 2B and 2C).

FIGS. 3A-3C are photographic cross-sectional images taken from the gauge section of each tensile specimen design. Compared to the other designs, V1 exhibited the lowest fraction of AM-induced defects.

FIG. 4A is a graph of yield strength for conventional and AM-processed Fe—Co. FIG. 4B is a graph of yield strength as a function of total tensile strain for each material condition. AM-processed material exhibited significantly higher strength and ductility than conventional Fe—Co.

FIG. 5A is a graph of yield strength for the V1 tensile specimen as a function of processing energy density. FIG. 5B is a graph of total strain-at-failure. With excessive energy density, the tensile ductility sharply declined.

FIG. 6 is a graph of yield strength as a function of total strain-at-failure for the V1 specimen processed with various energy densities. Conventional Fe—Co is included for reference. At the highest energy density processing conditions, AM material ductility approached conventionally processed Fe—Co.

FIG. 7A shows a representative location for simulated temperature histories at the center of the gauge section. The location is in the interior of the part along the centerline of the tensile axis. FIG. 7B shows qualitative temperature histories for all three specimen geometries as a function of time, showing increased temperatures when the heat source reached the larger cross-sectional areas of the tensile specimen grips.

FIG. 8 shows simulated temperature profiles for the three designs at a location within the upper grip section taken at a 20,000 s timestamp. The specimen without heat sinks exhibited a higher temperature throughout the part height, as opposed to the V1 and V2 designs.

FIGS. 9A-9C show cross-sectional optical images of the tensile specimens showing representative grain structures for the three designs. All specimens showed a predominately equiaxed grain structure. The V2 design grain structure was slightly coarser than V0 and V1.

FIG. 10 is an illustration of material, form, and function relationships constituting the conventional design space. The red dashed arrow is the new design pathway enabled by AM processing, wherein the form/geometry of the component can now directly control the material structure and thus material properties and function.

### DETAILED DESCRIPTION OF THE INVENTION

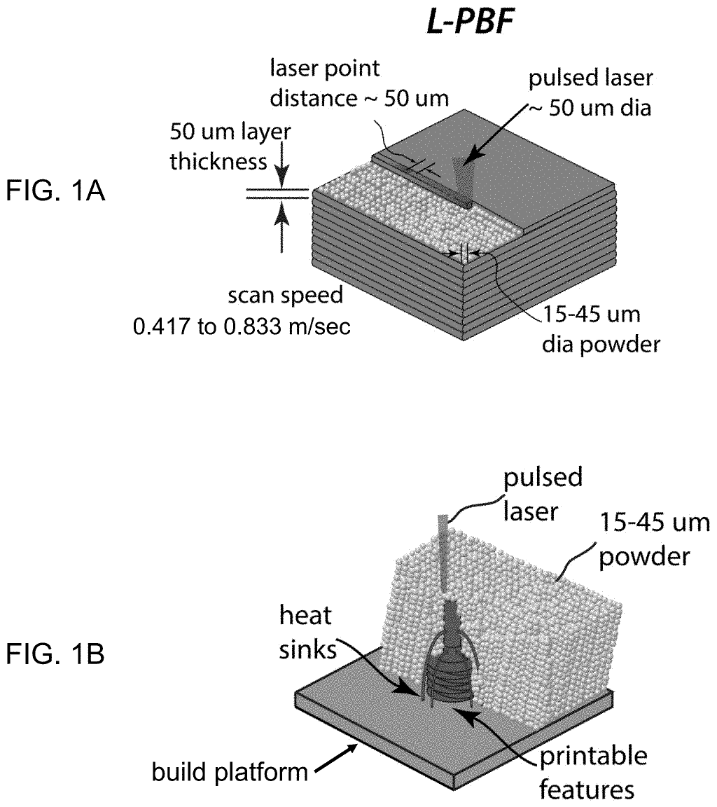

As shown in FIG. 1A, LPBF is an additive manufacturing process in which thermal energy from a high-power laser selectively melts and fuses regions of a powder bed layer by layer. Like any 3D printing technique, the design of a part or component begins with the creation of the 3D model using CAD software. The component is then cut into a multitude of layers by a slicer—in this case, the thickness of a layer can be about 50 μm in thickness. In order to start the printing process, the 3D printer fills the printing chamber with an inert gas and then heats it to the optimal printing temperature. A thin layer of powder is then applied to the build platform. For example, the powder can comprise spherical metal particles about 15 to 45 μm in diameter. A high-power pulsed laser then scans the cross-section of the part, locally melting and fusing the metallic particles together. When the layer is finished, the platform moves down, allowing another layer of powder to be added. The process is repeated additively, layer by layer, until the final part is obtained. The built part is allowed to cool and the unmelted powder is removed from the build plate to provide the printed end component. Post processing can be used to remove printing supports and heat treat the end component. Since the part is built layer by layer, the end component can be extremely complex and contain features not possible with conventional subtractive manufacturing processes.

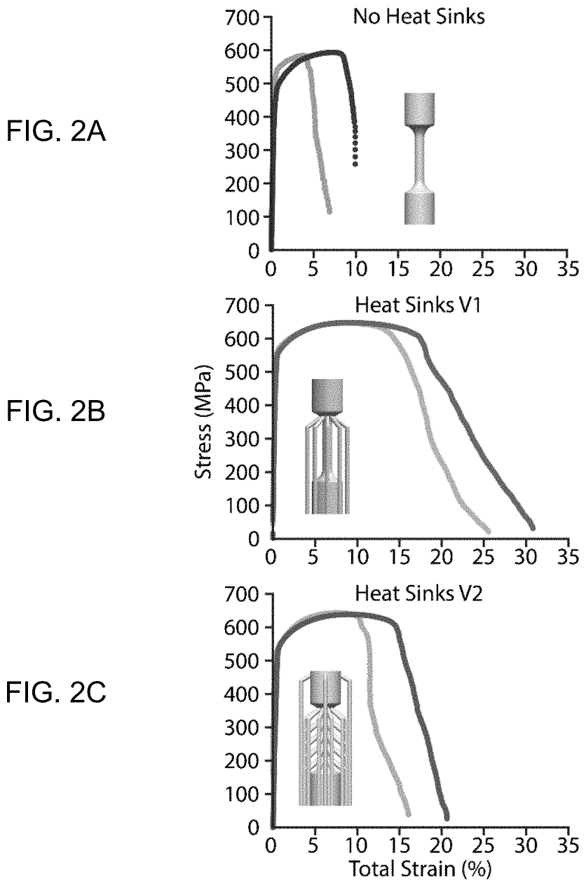

To demonstrate the invention, a conventional ASTM-based tensile specimen with a cylinder-based gauge section was selected as an exemplary geometry for manufacturing via LPBF, as shown in FIG. 1B. The insets in FIGS. 2A-2C illustrate the different processing approaches used to construct the exemplary tensile specimens. Two different morphologies were explored: 1) an unaltered tensile specimen geometry processed without secondary features (FIG. 2A) and 2) a tensile specimen with removable “heat sink” struts that were constructed concomitantly in two different configurations (FIGS. 2B and 2C). As shown in FIG. 2B, specimen V1 possessed a series of solid cylindrical struts that surrounded the periphery of the tensile specimen and terminated jointly at a single location near the upper tapered tensile specimen grip section. As shown in FIG. 2C, specimen V2 was constructed with a larger number of coaxial cylindrical struts surrounding the tensile specimen and terminated at various locations along the gauge length of the tensile specimen. The motivation for integrating cylindrical “heat sink” struts was to modify the thermal profile experienced by the tensile specimen during LPBF processing and facilitate pathways of enhanced heat transfer from the specimen to the surroundings. The specific exemplary designs were chosen based on results from the baseline build without struts, wherein significant failure commonly occurred near the upper portion. Prior to mechanical testing of the tensile specimens, the struts were removed, leaving behind a consistent tensile geometry for properties characterization.

The three tensile specimen designs were processed from binary Fe-50Co pre-alloyed powder (Sandvik) with a 15-45 μm distribution using a Renishaw AM400 (Wotton-under-Edge, UK) LPBF machine. Tensile specimens had dimensions of a 4 mm gauge diameter with a 22 mm gauge length and M12 printed threads on each end of the grips. The total length of each specimen was 54 mm. To isolate the role of the process design, processing conditions were held constant with a laser power of 200 W and an effective scan velocity of 0.833 m/s. An expanded set of processing conditions was explored for the V1 design by modifying the laser power over a range of 200 to 300 W, and effective scan velocities of 0.417 to 0.833 m/s to impose varying energy densities and investigate its effect on mechanical performance. Some of these additional processing conditions were not achievable for the specimen without heat sinks due to excessive heat accumulation and subsequent failure/drooping of the threaded ends during construction. All specimens were tested in the as-built condition after being cut off the build plate and without any secondary processing. Samples were produced using the “Meander” Renishaw scan strategy and a minimum of three specimens were tested for each design.

The effect of strut additions on thermal history was also evaluated using AM process simulations with the Sierra/Aria thermal finite element software suite. See S. T. D. Team, SAND2019-12296 (2019). This software package has been previously used to model the AM process, and a full description of the numerical formulation can be found in Johnson. See K. L. Johnson et al., Comput. Mech. 61, 559 (2018). These simulation differ slightly from Johnson due to the use of a planar heat source to activate a layer of material at a time rather than a Gaussian heat source matching the physical laser size. This change was made primarily due to the prohibitive computational expense of simulating each laser pass for a large LPBF part. Using a planar heat source sacrifices local thermal differences due to the scan path but is computationally efficient and well-suited to demonstrate differing thermal trends caused by geometry changes; e.g., the addition of struts.

A single build of each of the three different part geometries was modeled separately and centered on a 140×140×15 mm stainless steel baseplate representative of the LPBF process. The specimens were all meshed using tetrahedral elements and a desired element size of 0.3 mm, while the requested element size for the baseplate was 4 mm. The transition from fine to coarse elements occurred in the baseplate. A planar heat source with 0.25 mm thickness representing one agglomerated layer (equal to five physical layers) was translated from the baseplate to the top of the part. At each 0.25 mm layer location, the source was held for 0.5 s and then deactivated for 110 s before moving to the next layer. The 110 s delay was chosen in an attempt to replicate the correct cooling time for the experimental parts. The Renishaw machine used was operated in reduced build volume mode, which requires approximately 22 s for recoating time per physical layer. Because the physical layer thickness was 0.05 mm, an agglomerated layer thickness of 0.25 mm would require 5× the cooling time or 110 s. The thermophysical properties used in the simulations are shown in Table 1 below. In addition to those in the table, the latent heat of fusion value of 246.6 kJ/kg was applied across a 25-degree temperature range beginning at the solidus temperature of 1750K. See T. G. Woodcock et al., Calphad Comput. Coupling Phase Diagrams Thermochem. 31, 256 (2007); and J. E. Rodriguez et al., Acta Mater. 122, 431 (2017). Convection was only considered on the exterior surfaces of the parts and baseplate. To mimic the effect of surrounding powder, a convection coefficient of 8 W/m²·K was considered on the part exterior, while a value of 25 W/m²·K was used on the bottom of the baseplate to mimic partial conduction to the LPBF mounting brackets. See A. J. Dunbar, Analysis of the laser powder bed fusion additive manufacturing process through experimental measurement and finite element modeling (2016).

TABLE 1
Thermophysical properties of Fe-50Co alloy used in thermal simulations.

| | | Thermal | Specific |
|---|---|---|---|
| Temperature | Density | Conductivity, | Heat, Cₚ |
| (K) | ( kg/m³)^{1,2} | k (W/m/K)³ | (J/kg)⁴ |
| 295 | 8120 | 30.6 | |
| 375 | | 34.4 | |
| 400 | | | 398.9 |
| 500 | | | 517.4 |
| 700 | | | 404.3 |
| 800 | | | 507.1 |
| 900 | | | 810.2 |
| 1000 | | | 2094.4 |
| 1001 | | | 2138 |
| 1200 | | | 920 |
| 1244 | | | 1085.6 |
| 1300 | 7475.1 | | 585.5 |
| 1400 | 7443.8 | | 608.1 |
| 1600 | 7381.4 | | |
| 1800 | 7215.3 | | |

¹Carpenter Hiperco 50 Fe-Co-V Soft Magnetic Alloy, 0.15 mm Strip Heat Treated 843 C.
²P. Choufani, Measuring the Thermophysical Properties of Fe-Co alloys using Containerless Electrostatic Levitation Techniques (2012).
³G. Kozlowski et al., Contin. Mech. Thermodyn. 32, 247 (2020).
⁴A. S. Normanton et al., Met. Sci. 9, 510 (1975).

The resultant engineering tensile stress vs. strain curves for the three different design approaches are shown in FIGS. 2A-2C. Qualitatively, all three specimens produced a somewhat similar yield strength response. However, significant differences in the ductility were observed. As shown in FIG. 2A, specimens without heat sinks exhibited a typical low-strain ductility without significant work hardening and tensile necking. By comparison, as shown in FIG. 2B, specimen V1 was characterized by a drastic increase in the tensile ductility, and exhibited pronounced work hardening and plastic deformation including extensive tensile necking, in some cases displaying a 500% improvement in total strain-at-failure relative to specimens without the removable heat sink features. As shown in FIG. 2C, for specimen V2, notable improvements in strength and ductility were also observed relative to the design without heat sinks; however, properties were generally inferior to the V1 design.

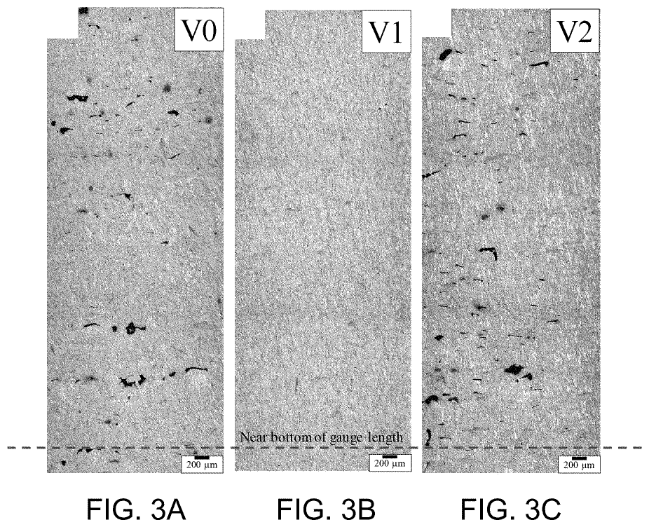

The slight deterioration of the mechanical properties for the V2 specimen, as compared to V1, could be from increased surface defects along the gauge length that resulted during the removal of the larger number of struts prior to tensile testing. This may reduce ductility when considering that FeCo-based alloys generally have a high notch sensitivity. See N. Stoloff, Ordered Alloys for High Temperature Applications, MRS Proc. 39 (1985); and M. R. Pinnel et al., Acta Metall. 24, 1095 (1976). Additionally, microstructural analysis revealed that the V1 specimens may, on average, have had fewer AM-induced defects compared to the V2 and V0 specimens. This is evident in FIGS. 3A-3C, which show a photographic mosaic of cross-sectional optical images taken along the gauge sections of each specimen type (excluding the grip and tensile fracture regions). Specimens in these images were etched electrolytically using a solution of 10 g ammonium persulfate and 100 mL DI H₂O. Density measurements via the Archimedes method (not shown) corroborated this hypothesis and showed that the V2 and V0 specimens had lower average relative density compared to V1 specimens.

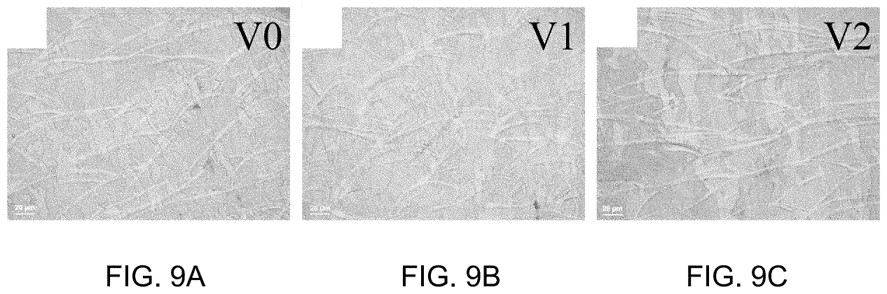

One possible reason for the differences in the defect density between the three specimens is that the defect variation resulted from the general stochastic nature of AM processing. Other possibilities may be linked to the different temperature profiles experienced by each design. For the V2 specimens, it is conceivable that the increased number of heat sinks could have generated a temperature profile that was below the alloy ductile-to-brittle transition temperature (˜450° C.), promoting defects during processing due to poor alloy workability. See T. L. Johnston et al., Philos. Mag. 12, 305 (1965); and N. S. Stoloff and R. G. Davies, Prog. Mater. Sci. 13, 1 (1968). For the V0 specimen, the temperatures during processing may have been high enough to transition to an austenitic microstructure. Repetitively cycling between austenite and ferrite phases could have generated additional residual stress, leading to an increase in defects. Consequentially, the V0 specimens may have been processed with a temperature profile between these two extremes, leading to near defect-free microstructures. Finally, slight differences in grain structure may have also affected the tensile performance (see FIG. 9 and associated text for more details).

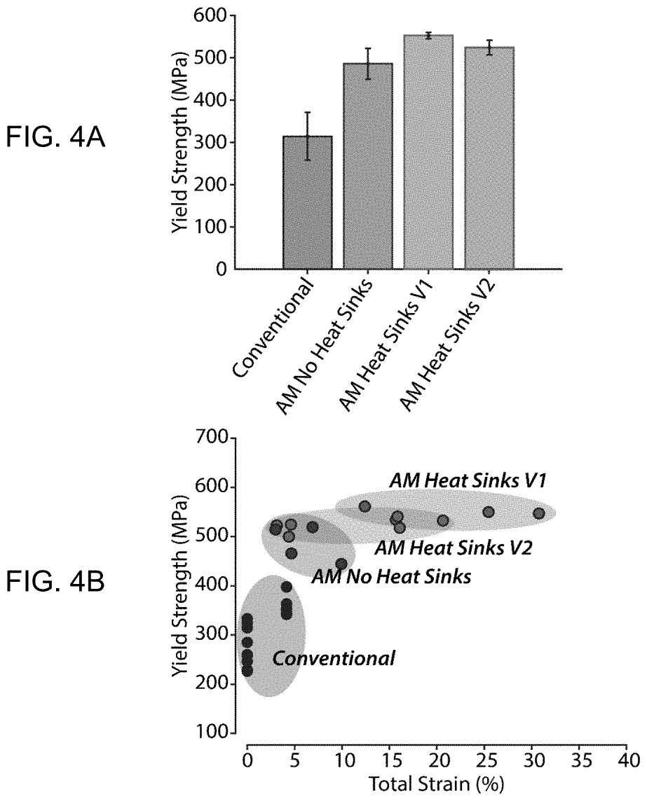

Quantitative analysis of the tensile response for the three AM-produced tensile specimens, with a comparison to literature data for conventionally processed Fe—Co, is shown in FIGS. 4A and 4B. Ultimate and yield strength, and strain-at-failure values are tabulated in Table 2. Data for conventionally processed Fe—Co were obtained from the references. See L. Zhao and I. Baker, Acta Metall. Mater. 42, 1953 (1994); M. J. Marcinkowski and H. Chessin, Philos. Mag. 10, 837 (1964); and E. P. George et al., Mater. Sci. Eng. A. 329-331, 325 (2002). FIG. 4A shows the yield strength values and FIG. 4B shows yield strength as a function of total strain-at-failure for each design. Notably, all AM-processed Fe—Co alloy conditions exhibited a significantly higher strength compared to the reported extremes for conventional material. Specifically, yield strength values for conventional Fe—Co generally are between 200 and 400 MPa, as compared to the average measured yield strengths of 486+/−37 MPa, 553+/−8 MPa, and 524.42+/−17.18 MPa for no heat sinks, V1, and V2 AM-processed specimens, respectively. Note, the upper bound strength for conventional Fe—Co represents material that was quenched from a high temperature above the disorder-order phase boundary to produce a primarily disordered BCC microstructure.

The AM-processed specimens also had, in some cases, significantly higher ductility compared to conventional material, as shown in FIG. 4B. Conventionally processed Fe—Co, even when evaluated in a fully (atomically) disordered BCC condition, has been reported to possess at most 4% strain-at-failure in tension. The ductility then decays to essentially 0% strain when the material is heat-treated to achieve the stable ordered B2 structure. AM-processed material, however, showed consistently higher strain-at-failure than conventional material with values of 6.11+/−3.01%, 23+/−9.45%, and 11.47+/−6.63% for no heat sinks, V1, and V2 specimens, respectively.

TABLE 2
Mechanical properties data for the three AM-processed Fe-Co designs.

| | UTS | Std UTS | Yield | Std Yield | Strain | Std Strain |
|---|---|---|---|---|---|---|
| Design | (MPa) | (MPa) | (MPa) | (MPa) | (%) | (%) |
| No Heat | 577.42 | 15.17 | 485.94 | 36.69 | 6.11 | 3.01 |
| Sinks | | | | | | |
| Heat | 649.66 | 3.74 | 552.77 | 7.55 | 22.87 | 9.45 |
| Sinks V1 | | | | | | |
| Heat | 623.11 | 25.56 | 524.42 | 17.18 | 11.47 | 6.63 |
| Sinks V2 | | | | | | |

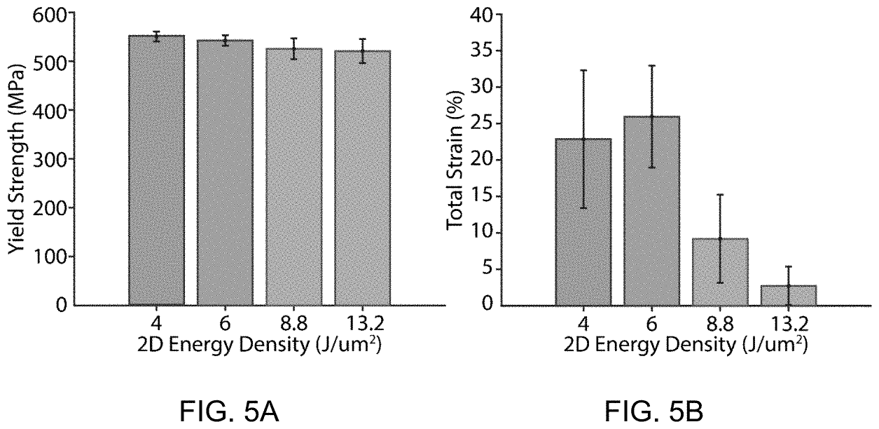

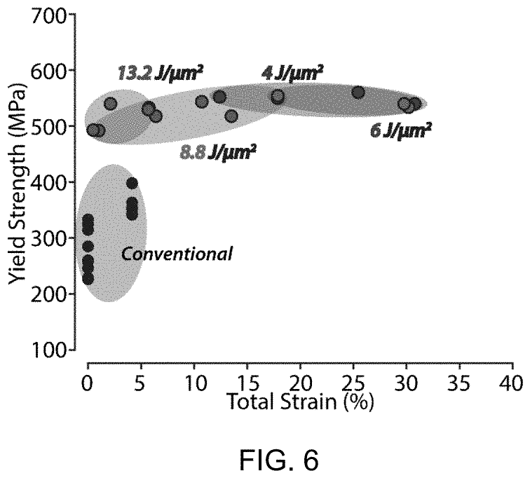

While the impact of the designed processing methodology is apparent in enabling unusual performance for exemplar tensile specimens, the role of processing conditions was also important to consider. FIGS. 5A and 5B show the effects of the processing conditions, expressed in terms of a 2D imposed energy density, on yield strength (FIG. 5A) and total strain-at-failure (FIG. 5B) for the V1 specimen. Unlike the strength of AM-processed specimens, which was essentially unaffected by the energy density ranges investigated, the ductility was significantly impacted and exhibited notable variability. The highest ductility conditions were observed for specimens produced with the lowest energy densities of 4 and 6 J/μm², respectively. With increased energy density to 8.8 and 13.2 J/μm², the V1 specimens exhibited a notable decrease in ductility to values that approached conventionally processed Fe—Co. However, at the extreme energy density values utilized for the V1 specimen geometry, the V0 specimen designed without heat sinks could not be processed due to excessive heat accumulation during processing. However, compared to conventionally processed material, and with the exception of the highest energy density condition, AM processing promoted significant improvements in both strength and ductility for an otherwise low strength and low ductility alloy, as shown in FIG. 6. Furthermore, strength improvements were also noted even for the highest energy density condition.

To contextualize the impact of the processing method of the invention, the product performance, production yield, and manufacturing implications are considered. For the former, consider the yield strength vs. total strain plot in FIG. 4B and FIG. 6. Notably, when comparing the data envelopes for conventional Fe—Co with the experimental specimens, AM-processed material exhibited a remarkable deviation from the traditionally inverse correlation with strength and ductility that limits most conventionally processed metals. AM processing enabled a 300% increase in strength with a simultaneous order-of-magnitude improvement in the ductility in the Fe—Co alloy relative to conventionally processed material. This performance represents an unprecedented improvement in mechanical properties for the traditionally low strength and low ductility Fe—Co alloy system and demonstrates the value proposition of implementing AM-based processing strategies to favorably tailor material properties. The removable struts were implemented to modify the local solidification and cooling conditions during processing to minimize effective temperature rise in the specimens layer-by-layer and, especially, along the upper portion of the specimen further displaced from the build plate. This effectively mitigated the temperature-induced failure of specimens during processing from excessive heat accumulation and defect formation.

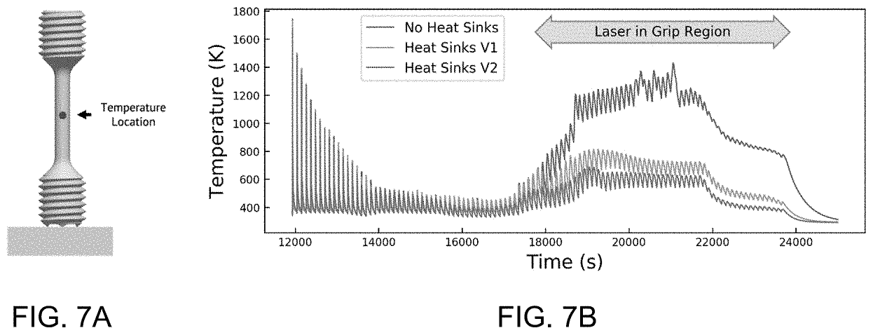

The thermal simulations further confirm the reduction in temperature rise for the specimens with heat sinks. Temperature histories were recorded at a point in the center of the gauge section for each of the specimen geometries, as shown in FIG. 7A for the geometry without heat sinks. The resulting thermal histories for all three geometries are shown in FIG. 7B. These temperature values are qualitative due to the use of a planar heat source and agglomerated layer size used. However, trends in temperature profiles are representative of the additive process.

Soon after the heat source reached the point of interest, the thermal histories were very similar, with V2 showing slightly lower temperatures overall due to the numerous struts attaching throughout the length of the specimen. The most dramatic differences occurred once the heat source reached the grip sections. Due to the large increase in the cross-sectional area for the grip, as compared to the gauge section, excessive heat accumulated in the part. This led to a significant temperature rise for the grip far above what was experienced by the gauge section. At approximately 18,000 s, the V1 struts, which were previously disconnected from the tensile specimen, joined the grip section and led to a significant decrease in temperature. Conversely, for the geometry with no heat sinks, the temperature profile continued to increase. Perhaps as expected, V2 showed only a minor increase in temperature during this stage of the build due to the repeating strut attachments to the tensile specimen. At approximately 22,000 s, the temperatures dropped slightly due to an internal hex key-shaped channel in the top of the grip that reduced the local cross-sectional area. After completion of the build, the heat source was removed and the parts cooled down to ambient temperature.

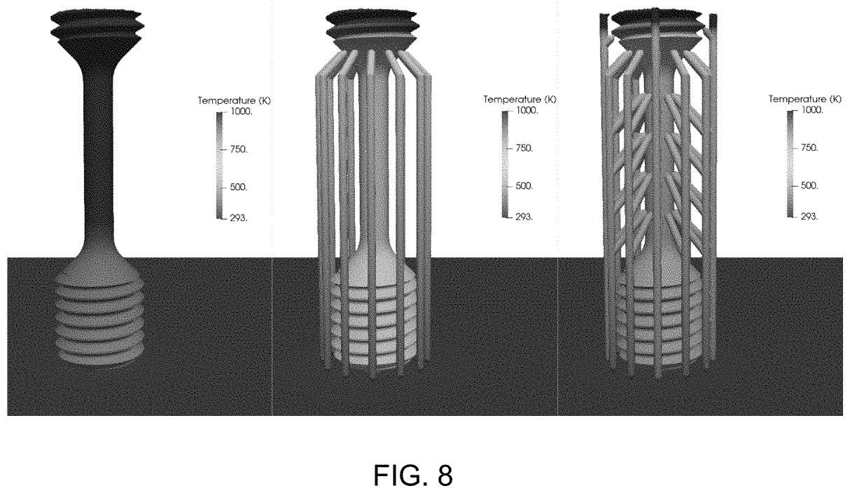

Though these temperature profiles are qualitative, they give important insights into a likely mechanism for the different mechanical responses between designs. The thermal predictions suggest that the V0 specimen experienced temperatures above the alloy ordering temperature, 730° C. (1003K), and possibly into the austenitic phase-field (983° C., 1256K) for nearly an hour (19,000 to 22,000 s). Under these types of thermal conditions, the material would likely cycle between multiple phase regions. Notably, the temperature profile for the V0 specimens near the end of the build (from ˜22,000 s to end of the simulation) was in a high atomic mobility region for the B2 phase transformation. This suggests that the V0 design had a significant fraction of the B2 phase, which would reduce strength and ductility. See D. W. Clegg and R. A. Buckley, Met. Sci. J. 7, 48 (1973). Conversely, the V1 and V2 specimens were likely heated several hundreds of degrees below the disorder-order phase boundary in a region of lower atomic mobility, limiting the extent of the B2 phase transformation and enabling higher strength and ductility. FIG. 8 shows another representation of the different thermal histories for the three designs at a location well within the upper grip section at 20,000 s into the simulation. Notably, the V0 design had a higher temperature throughout the specimen height, as opposed to V1 and V2, which experienced significantly more localized heat accumulation confined to the grip sections.

At the material level, mechanisms leading to the drastically improved mechanical properties for the Fe—Co alloy are speculative. However, the rapid cooling and minimal layer-by-layer temperature rise facilitated by AM has been shown to promote the formation of an atomically disordered BCC structure in Fe—Co. See A. B. Kustas et al., Addit. Manuf. 21, 41 (2018); and A. B. Kustas et al., Addit. Manuf. 28, 772 (2019). These thermal conditions were likely enhanced by the local strut artifact design, encouraging suppression of the B2 ordered phase, and promoting higher strength and higher ductility. See T. Sourmail, Prog. Mater. Sci. 50, 816 (2005); and R. S. Sundar and S. C. Deevi, Soft magnetic FeCo alloys: alloy development, processing, and properties (2005). Thus, it is possible that local thermal management via AM processing was the sole mechanism leading to enhanced properties for the Fe—Co alloy through stabilization of the disordered BCC structure. However, the performance of AM-processed material was significantly improved relative to that typically observed in fully disordered material when conventionally processed. Therefore, additional atomic-scale mechanisms, inherited from the AM processing, must be present in order to facilitate the remarkable properties. This is especially true considering that AM-produced Fe—Co can exhibit relatively poor mechanical properties in some instances, as described herein for the higher energy density processing conditions and in other recent evaluations. See T. Riipinen et al., Rapid Prototyp. J. 25, 699 (2019); and T. F. Babuska et al., Acta Mater. 180, 149 (2019). A tentative hypothesis, based on high-resolution material characterization and atomic-scale computational analysis, suggests that rapid solidification of LPBF-type AM processes can be utilized to produce microstructural features that act to simultaneously impede and accommodate dislocations during plastic deformation. See T. F. Babuska et al., Acta Mater.180, 149 (2019). Microstructural features, such as nanoscale voids, dislocation cells, sub-micron cellular/dendritic structures, oxides, etc., have been noted to form in LPBF-processed material, including Fe—Co. These features could enable additional plastic deformation accommodation mechanisms and lead to higher strength and extended ductility, as was similarly proposed by Wang for AM-processed 304L stainless steel. See Y. M. Wang et al., Nat. Mater. 17, 63 (2018). The formation of these features would likely be enhanced by the application of local heat sink artifacts integrated for augmented heat transfer and cooling rates. In addition to the multiscale microstructural features typical of AM-processed material, rapid cooling, similar to the cooling rates found in laser-based AM processing, has been shown to promote martensitic phases in Fe—Co—V alloys, which may influence mechanical behavior. See S. Mahajan et al., Met. Trans. 5, 1263 (1974); and J. A. Ashby et al., Met. Sci. 11, 91 (1977). However, no such phases have been confirmed in AM-processed binary Fe—Co to date. Finally, the AM-processed Fe—Co alloy specimens all possessed a relatively fine (5-20 μm diameter), predominately equiaxed grain structure in the as-built condition (see FIGS. 9A-9C), which would likely promote increased yield strength from Hall Petch strengthening mechanisms. See D. F. Susan et al., J. Mater. Res. 33, 2176 (2018). Only the V2 specimen exhibited a slightly coarser grain size relative to the V0 and V1, which in the absence of defect density differences, would promote lower strength and higher ductility.

A practical processing benefit of the process design methodology was also identified when comparing the production yield/efficiencies for the various specimen designs. In the case of the design without heat sinks, 50% of the specimens were constructed with sufficient quality to enable mechanical testing/use. Specimens that could not be tested generally failed during the layerwise processing from excessive heat accumulation and produced low quality threaded ends that were unusable with the tensile grips. This result is consistent with the simulation results, which predicted near melt temperatures in the grips for the V0 specimens. Product and testing yield were found to significantly increase for specimens with the removable heat sink artifacts for both V1 and V2 specimens, which yielded 75% and 90% test/use rates, respectively, see Table 3 for details. These findings demonstrate the value of utilizing AM to design for improved manufacturability to increase the rate of component use in line with traditional “Design for Additive Manufacturing” guidelines.

TABLE 3
Production and testing yield for the three AM designs.

| | Total | | Successful | | |
|---|---|---|---|---|---|
| Design | Printed | Total Yield | Tests | % Yield | % Tested |
| No Heat | 12 | 8 | 4 | 66.67 | 50 |
| Sinks | | | | | |
| Heat Sinks | 6 | 4 | 3 | 66.67 | 75 |
| V1 | | | | | |
| Heat Sinks | 12 | 10 | 9 | 83.33 | 90 |
| V2 | | | | | |

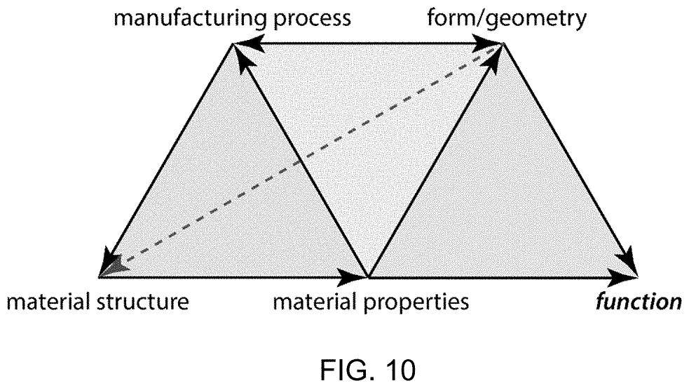

As shown in FIG. 10, the significance of the method of the present invention can be visualized in the context of the material, form, and function diagram that is frequently used to characterize manufacturing processes. Fundamentally different from conventional manufacturing methodologies, the inventive method shows that AM processing enables the component form/geometry to directly influence the material structure, properties, and function, in addition to the processing/manufacturing parameters of the technique. Thus, this method of the present invention provides a second degree of design freedom for the end-user that is not available with conventional manufacturing to tailor final component structure-properties relationships.

The present invention has been described as a method of improving the strength and ductility of brittle intermetallic alloys through additive manufacturing. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for improving the strength and ductility of a brittle intermetallic alloy, comprising:
designing a component comprising an intermetallic alloy wherein the design further comprises at least one heat sink strut to modify the thermal profile of the component during laser powder bed fusion additive manufacturing, and
building the component concurrently with the at least one heat sink strut by laser powder bed fusion additive manufacturing.

2. The method of claim 1, further comprising removing the at least one heat sink strut after the building step to leave the component.

3. The method of claim 1, wherein the thermal profile is modified to keep a temperature of the intermetallic alloy lower than an alloy ordering temperature during the building step.

4. The method of claim 1, wherein a layerwise cooling rate of the component during the building step is greater than 1000° C./sec

5. The method of claim 1, wherein the intermetallic alloy comprises an Fe—Co alloy.

6. The method of claim 5, wherein the composition of the Fe—Co alloy is between 25 and 70 atom percent Co.

7. The method of claim 1, wherein an energy density of the laser during the building step is greater than 4 J/μm².

8. The method of claim 1, wherein a power of the laser during the building step is between 200 and 300 W.

9. The method of claim 1, wherein the scan speed of the laser the during building step is between 0.417 and 0.833 m/sec.
